(19) United States
(12) Patent Application Publication
(10) Pub. No.: US 2006/0242663 A1
(43) Pub. Date: Oct. 26, 2006

(54) IN-EMAIL RSS FEED DELIVERY SYSTEM, METHOD, AND COMPUTER PROGRAM PRODUCT

(75) Inventor: Nicholas B. Gogerty, La Jolla, CA (US)

Correspondence Address: BARNES & THORNBURG LLP, P.O. BOX 2786, CHICAGO, IL, 60690-2786, US

(73) Assignee: Inclue, Inc., La Jolla, CA (US)

(21) Appl. No.: 11/379,856

(22) Filed: Apr. 24, 2006

Related U.S. Application Data
(60) Provisional application No. 60/673,894, filed on Apr. 22, 2005.

(51) Int. Cl. G06F 17/00; H04N 7/10; H04N 7/025; G06F 3/00; H04N 5/445; G06F 9/00

(52) U.S. Cl. 725/34; 715/752; 725/35; 725/42

(57) ABSTRACT

A system, method, and computer program product that allows an email program to passively display information in conjunction with incoming emails that include RSS feeds and may include contextual advertising at the same time. The system, method, and computer program product of the present disclosure targets at least a portion of an RSS feed at the time the email is delivered, and may be used in a substantially transparent way to avoid distraction of the end-user.

### RELATED APPLICATION

This application claims the benefit of U.S. Provisional Application No. 60/673,894 filed Apr. 22, 2005, the disclosure of which is hereby incorporated by reference in its entirety.

### BACKGROUND AND SUMMARY

The present disclosure relates generally to dynamic insertion of information into e-mail and more specifically it relates to a method for displaying information within email that allows email users to quickly view their incoming RSS feeds and other pertinent information simultaneously.

Typically, the information that is dynamically inserted into the body of an e-mail is comprised of advertisements placed by an email sender that may be related to the subject matter of the email being sent. Advertisers recognize the opportunity to present their advertisements to email recipients at the time the emails are displayed. Advertisers desire to key the advertisements being displayed to the email reader's interests. One problem with traditional contextual advertising email systems is that the preferences of email recipients cannot be established prior to sending the email, and a change in such preferences cannot be captured over time.

One way an email user can express an interest is by subscribing to selected news feeds. Electronic news feeds may be provided in a number of ways. One way is using the widely published RSS standard. News publishers can automatically push articles to subscribers by formatting the articles according to the RSS standard and allowing subscribers to access the articles using RSS readers or via web pages designed to incorporate such articles automatically.

Briefly, in accordance with the foregoing, disclosed is a system, method and computer program product that allows an email program to display information in conjunction with incoming emails that include RSS feeds and may include contextual advertising at the same time. The system, method, and computer program product of the present disclosure targets at least a portion of an RSS feed at the time the email is delivered, and may be used in a substantially transparent way to avoid distraction of the end-user.

Also disclosed is a system, method, and computer program product for an affiliate revenue sharing structure related to the distribution of the RSS feed email add-on product. Typical software affiliate revenue share systems are comprised of banner ads, link exchanges, contextual web ads, and affiliate marketing programs. Existing software affiliate revenue share systems typically offer either revenues for distribution of software or for the displaying of advertising on websites. It is desirable to offer a revenue stream for those distributing software applications and to continue that revenue stream even after a user stops consuming or accessing the publisher's website information.

The disclosed system includes at least one publisher-distributor of RSS feed information. The publisher distributes the RSS feed add-on modules to end users for use with their existing email systems. End-users are able to view the RSS feed inside their delivered emails and are also shown advertisements for subject matter related to the information in at least a portion of the RSS feed, in the RSS feed headlines, or somewhere else in the e-mail software application. Clicking on the advertisements creates a link-exchange event causing an advertisement landing web page owner to pay for the event. Revenue derived from the click is shared back with the publisher or a network of publishers. The publisher is thus incentivized to continue distribution of the add-on module and receives a continuous stream of revenue for distributing their content and/or the software product which may be, for example, the RSS reader product or news aggregator being distributed.

Additional features will become apparent to those skilled in the art upon consideration of the following detailed description of drawings exemplifying the best mode as presently perceived.

### BRIEF DESCRIPTION OF THE DRAWINGS

The present disclosure will be described hereafter with reference to the attached drawings which are given as a non-limiting example only, in which:

FIG. 1 is a screen display of one embodiment of a email display that includes an RSS feed and contextual advertising;

FIG. 2 is a simplified diagrammatic representation tracking revenue derived from distribution of an RSS feed email add-on by publisher-distributors;

FIG. 3 is a simplified diagrammatic representation of the system of FIG. 2 showing multiple publisher-distributors distributing the email add-on product to multiple terminals;

FIG. 4 is a screenshot of an embodiment of the present system, method and computer program product used in connection with Microsoft Outlook™.

FIG. 5 is a screenshot of an embodiment of the present system, method, and computer program product used in connection with Microsoft Outlook Express™.

FIG. 6 is an example of a mixed text and advertisement embodiment of an add-on panel for the disclosed system, method, and computer program product;

FIG. 7 is another embodiment of the panel of FIG. 6.

FIG. 8 is an example of photo based embodiment of an add-on panel for the disclosed system, method, and computer program product; and

FIG. 9 is an example of a video clip or audio/video clip embodiment of an add-on panel for the disclosed system, method, and computer program product.

The exemplification set out herein illustrates embodiments of the disclosure that is not to be construed as limiting the scope of the disclosure in any manner.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure and is not intended to be exhaustive or to limit the disclosure to the details of construction and the arrangements of components set forth in the following description or illustrated in the drawings.

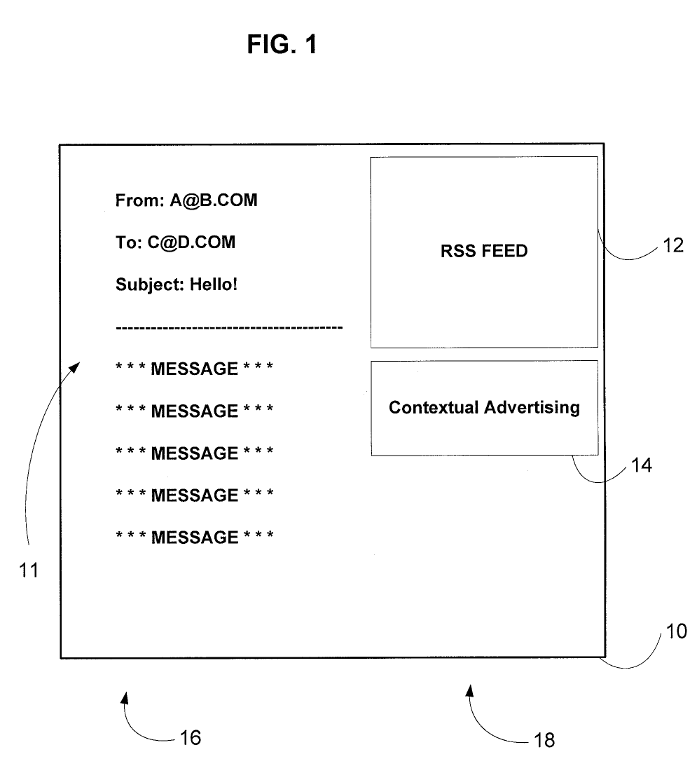

FIG. 1 shows an email display 10 of the present disclosure. Email display 10 may correspond to the window or screen display in which an email is viewed, which may be any email delivery product, including but not limited to, web-based email delivery such as Hotmail™, Yahoo™, MSN™, or Gmail™, or installed/client-based email programs such as Microsoft™ Outlook™, Novell™ Groupwise™, LotusNotes™, or proprietary email readers on portable electronic devices, set-top boxes, personal video recorder, or other electronic devices.

Email display 10 includes an email body portion 11 that includes typical email components including sender information (from, to, subject, date) and a message body 11. As is known in the art, body 11 may include text, graphics, and/or other audiovisual components which may reside in the email code or be retrieved as hyperlinks or retrievable objects when the email is opened. The email code may also include, or act as a pod or wrapper to hold, a media file, such as an MP3, MPEG, MOV, WMA, or other media file. The RSS feed may thus be used as a form of podcasting or videocasting.

Email display 10 also includes an RSS feed portion or panel 12. An email display 10 that includes RSS feed or panel 12 may be generated by interrupting the display of a standard email display by the email program, regenerating a new email display dynamically, such as by creating duel column html format document, and then displaying the email body 11 in the left column and the RSS feed in the right column. The content of the RSS feed will depend on preferences set in the add-on program, or the default settings in place when the add-on program is distributed and/or installed. The identification of the data feed as an RSS feed in this disclosure is used for illustrative purposes only. Other data feeds for providing news and other information may be used as well including but not limited to XML, ATOM, MRSS, other forms of micro syndicated media and messages.

A selected RSS feed may be displayed in the RSS feed portion or panel 12 in a complete or truncated form, or as a series of headlines or topic descriptions. An RSS headline is a brief text description of the data within an RSS feed or data record. The RSS headline can be displayed textually, graphically, by audio, voice or in video. The RSS headline is any electronic representation used to indicate the subject matter to which the full RSS feed may relate.

The RSS feed may also include other information such as textual, pictorial, video, audio, hyperlink information, thumbnails or other abbreviated files including video thumbnails, HTML, Flash, a javascript routine or representation, external data inputs including IM, VOIP, video chat, streaming media, or other third party information. This information may include additional RSS headlines, advertising, or third party contacting information. The other information may take many forms, including but not limited to instant messages, SMS, MMS, text, RSS, MRSS (multimedia RSS), HTML, hyperlinks, video, audio, voice, or any other form of electronic communication. The panel 12 can be auto-updating and can support hyperlinks to external browsers.

Email display 10 may also include contextual advertising portion 14 that includes web advertising that is contextually related or relevant to at least a portion of the information in RSS feed portion 12. Any method of keying the contextual advertising to the RSS feed can be used including matching keywords, context, or phrases in the RSS feed or RSS feed headline to keywords or metatags in the advertising. Matching may also use fuzzy logic to allow matching without exact letter-for-letter matching. The contextual advertising portion may also be configured to store keywords that have some connection with the subject matter being advertised, and to display advertising when one or more of the keywords is found in at least a portion of the RSS feed. Participants in a distribution framework for the add-on module may purchase or bid on such keywords, in such context described as “sponsored keywords,” to have preferential treatment with respect to displaying their own advertising. The contextual linkage may also be based on user behavior such as click patterns or web site visit patterns, that may, for example, be stored in cookies. The linkage may also be based on the user's I.P. address or some location identifier.

Generally, it may be desirable to display the email body 11 on the left hand side 16 of the email display 10, and the RSS feed data 12 and contextual advertising 14 in the right or upper right hand side 18 of the email display 10. This arrangement may be beneficial where the add-on provider wishes to minimally distract an end-user from the email body 11 because it has been found that readers of electronic documents start with, or focus most intensely on, the upper left hand portion of the display first. If an add-on distributor wishes to force attention to the RSS feed 12 and/or contextual advertising 14 first, or simply has a different configuration preference, the elements shown in FIG. 1 may be situated in any number of alternative configurations, including but not limited to reversing left and right columns 16, 18, or moving the elements to a vertical arrangement, or moving one or both of the RSS feed 12 and contextual advertising 14 to the beginning or end of the email display 10.

The RSS feed 12 and contextual advertising 14 may be displayed by being superimposed over email display 10 only while being displayed in a host email program. This allows display of the email containing the RSS feed 12 and contextual advertising 14 to be limited and tailored to a specific user. In such an embodiment, forwarded, stored, printed, or archived emails would not contain the associated RSS feed 12 or contextual advertising 14. Separating the email from the RSS feed and advertising in this manner may be advantageous for several purposes including but not limited to reducing email size, keeping preferences for news or other feed-delivered information confidential, and other purposes.

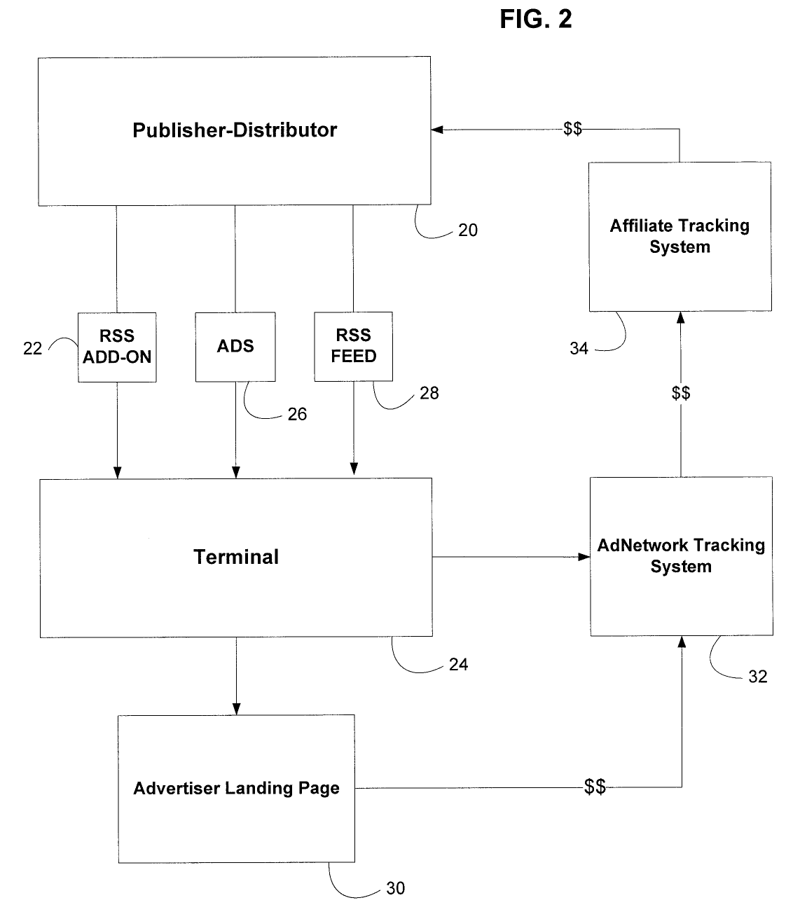

As shown in FIG. 2, a publisher or publisher-distributor 20 may distribute an RSS add-on 22 that functions as described above to an end user for use on their terminal 24. A terminal may be any computing device or interface capable of receiving an email and/or a data feed including but not limited to a personal computer, tablet PC, laptop, personal digital assistant, cell-phone, set-top box, workstation, phone, television, satellite radio, MP3 player, or other electronic device. The terminal may include the host email reading software as residing in its native form on the device, or may be delivered by an application such as a browser. As noted above, the host email program may be used to display a variety of content types in association with the email including text, instant messages, SMS, video messages, audio, voice, email, graphics, multi-media content, or other electronic communication.

For purposes of this disclosure, a publisher 20 is an entity which produces information for end users. The information may take any form including by way of example, but not limitation, the form of news, media, data, alerts, horoscopes, weather updates, advice, or other forms of information in a graphical, textual, video, audio, or digital format. Information publishers are usually individuals or corporations which use computers and other forms of electronic information creation to produce information. In some instances publishers may use a machine to produce information by collecting information from other sources or creating new information via manipulation of data. A publisher could be anyone including, but not limited to a web publisher, print distributor, software distributor, or other entity involved in information creation or distribution. A particular feed or combination of feeds in a panel 12, may also be from more than one source, and thus provide a combined view from more than one publisher.

The publisher 20 may distribute the add-on 22 with RSS reader preferences defaulting to the publisher's RSS feed 28, or requiring the RSS feed portion 12 initially to include at least the publisher's RSS feed 28. In an embodiment which includes the contextual advertising portion 14 in the regenerated email display, advertising or other information is displayed which may be any form of information displayed to the end-user with the intent of establishing a commercial relationship at some time between the viewer and the advertiser and may include but is not limited to a banner, contextual display, text, video, flash, audio, graphic ads, web phone links, voice over IP links, or interactive component allowing the end-user to contact the advertiser either via e-mail, website, phone call, video chat, or other form of electronic interaction (collectively “Ads 26”). Although FIG. 2 shows the ads 26 being sent directly from the publisher 20, it should be noted that the ads may be provided by third parties or be provided from outside service providers through a link exchange service, advertising network, or the like. Link exchange providers include, but are not limited to Yahoo™ networks, Kanoodle™, Contextualnext™, Bidclix™, Quigo™ (Ad Sonar™), Industry Brains™, and Google™ (AdSense™). Voice over IP links may be used in connection with a pay per click, pay per action, pay per impression, or pay per call revenue model, which is similar to a pay per click model, but instead of revenue being shared for a clicked advertisement, revenue is shared when a VOIP link is clicked to generate a call over a VOIP network or the like. Revenue may be based on a variety of factors including but not limited to placed calls, calls leading to requests for information, and calls leading to actual sales. An example of a VOIP link label may be “Click to skype™ chat with a travel agent.” The use of skype™ in the previous example is meant to be one non-limiting example of VOIP service. Other services may be used as well.

In use, an end user is presented with the email display 10 on the end user's terminal 24. The user can click on the RSS feed portion, or on a particular article or headline to open a browser window connecting the end-user to a more complete display of the associated content. Similarly, clicking on the ad will open a browser or otherwise connect the end-user to more complete display of the products or services being advertised. Alternatively, the expanded display may be displayed or superimposed inside the host email program in a manner similar to the RSS feed portion and/or contextual advertising portion. In an embodiment where the host email program is browser-based, the user may use standard browser navigation controls, such as a link, a back button, a forward button, or other controls, to utilize the expanded display. A non-browser based email program may also include browser controls for navigating the expanded display inside the email program. That more complete or expanded display may be a web site, web page, banner, or delivery of some other electronic information referred to collectively as an advertiser landing page 30.

Activating the advertiser landing page 30, such as by clicking on a link leading to the advertiser landing page 30, or by arriving at the page 30 using a URL that includes some tracking information, may cause an advertising network or ad network 32 to record the event. Typically, the advertiser who controls the landing page 30 will pay the ad network 32 some compensation for the activating event such as a per click compensation, such as, for example, $0.50 per click, or pay per call compensation, such as $5 per call. The ad network 32 in turn may credit a portion of the revenue received from the advertiser to the provider of the link or advertising, which in the scenario described above, would be the publisher-distributor 20.

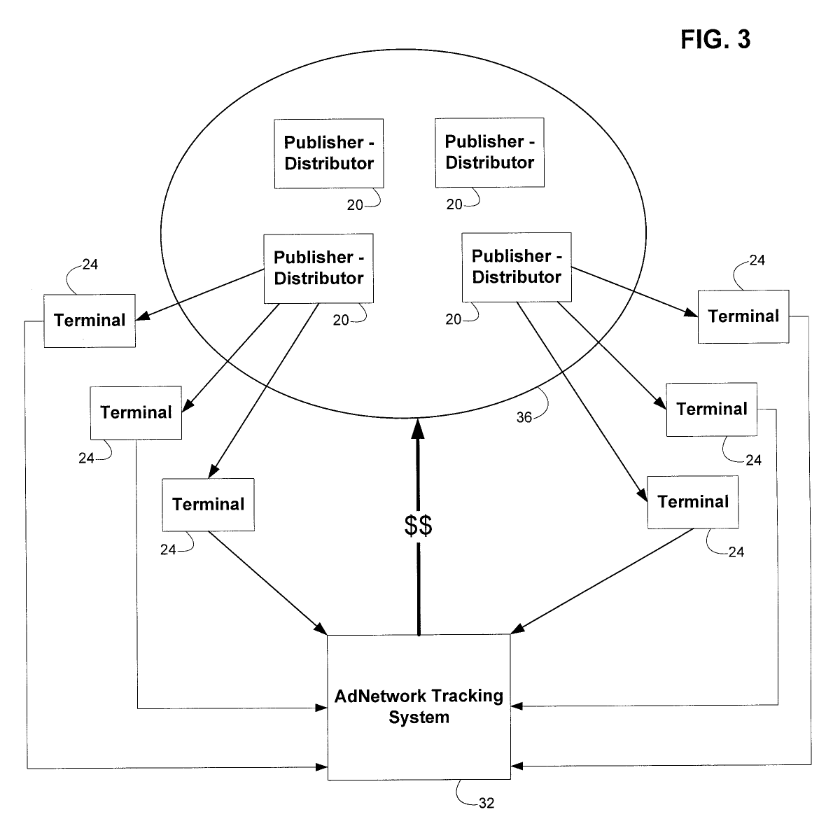

An intermediate or internal affiliate tracking system 34 may be used to distribute the revenue from the ad network 32 among the publishers in a scenario where more than one publisher is incorporated into an affiliate network 36 as shown in FIG. 3 and discussed more fully below. The affiliate tracking system 34 may be notified of the activating event at the same time as the ad network 32 using click tracking technology known in the art. The affiliate tracking system 34 may include a database for maintaining records of the source of the activation or click of the ad, the entity associated with the ad, the identity of the RSS reader which displayed the ad, and general information associated with the ad network system 32.

The publisher affiliate network model shown in FIG. 3, shows another model that may be used in connection with the present disclosure. Member publisher-distributors 20 distribute the add-on to their respective end-users for use with the end-users' terminals 24. Revenue may be shared among the publisher-distributors 20 because the publisher-distributors may realize that the end-user may select the RSS feeds of other member publisher-distributors 20 once the add-on has been activated in addition to or instead of the particular distributors publisher's RSS feed. A variety of revenue sharing models may be implemented including by way of example, but not limitation, revenue based on the number of add-on modules distributed, the frequency of click-throughs of a particular RSS feed, advertisement or message, the number of feeds or amount of content being provided by a particular participating member publisher-distributor, or any combination of these factors with or without other factors.

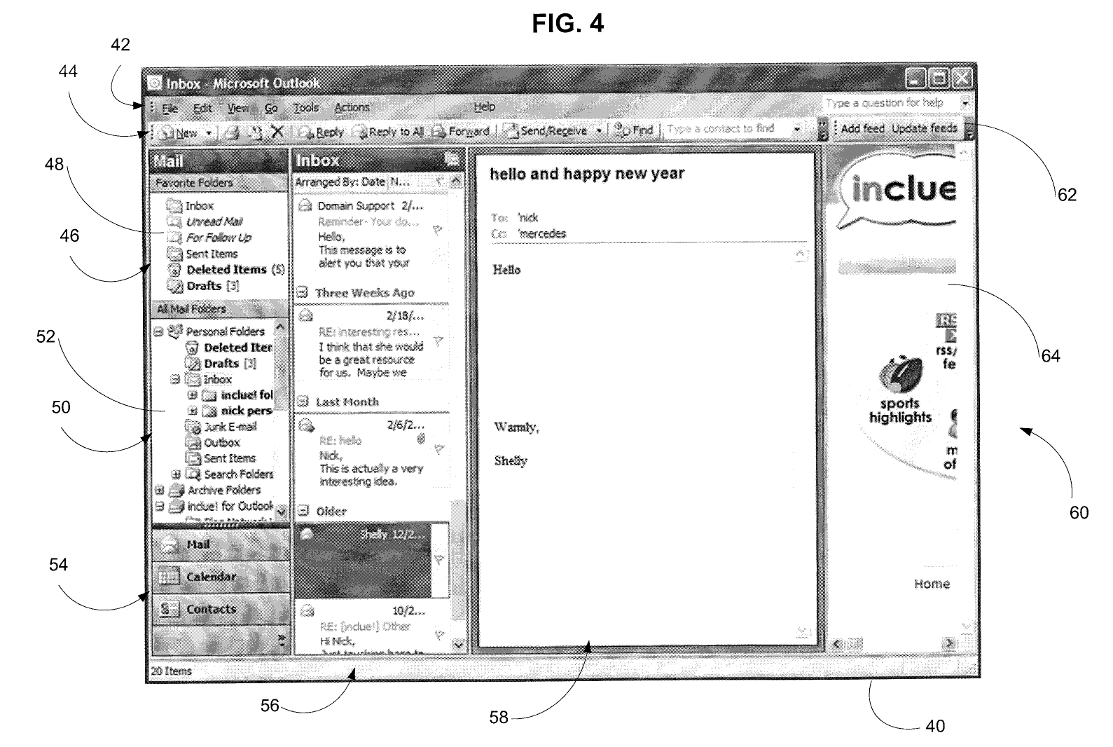

FIG. 4 is an illustrated embodiment of a screenshot of the present method for use in connection with Microsoft Outlook™. Although the embodiment is shown for Outlook™, the present system, method, and computer program product may be used with any email program, including but not limited to Lotus Notes™, Novell Groupwise™, and other client based email programs as well as web-based email programs such as Hotmail™, Microsoft Live™, Gmail™, Yahoo™ Mail, and others. The base features of the Outlook™ interface are described here briefly as a context for the features provided by the present disclosure without any limitation thereto.

As shown in FIG. 4, interface 40 includes a standard file menu 42 with menu selections that include File, Edit, View, Go, Tools, Actions, and Help. Interface 40 may also include a toolbar 44 with a standard buttons and/or icons corresponding to generating a new mail, printing, deleting, sorting, replying, replying to all, forwarding, initiating a send/receive, finding, contact searching, and other features. Any of the features described herein with interface 40 or the like may be effectuated using one or more buttons, menu selections, tool bar buttons, dropdowns, or other selections in menu bar 42, toolbar 44, or elsewhere.

Interface 40 also include a mail favorites sections 46 which may include one or more folders 46 with designations such as inbox, unread mail, for follow-up, sent items, deleted items, and drafts. Interface 40 may also include a mail folders section 50 with individual folders 52 which may include one or more of the titles shown. Links to access other features 54 may also be included including mail, calendar, and contacts links. An active item panel 56 may also be included that shows items in the selected folder(s). In the illustrated embodiment, the inbox is currently selected. Individual mail items, sorted in any method including, for example, chronologically in subcategories may be shown. The active email is displayed in window 58.

Interface 40 includes an RSS portion or panel 60 of the present disclosure. Panel 60 includes feed information 64, and in one embodiment, contextually based advertising as described above. An add feed and/or update feed button 62 may also be displayed to allow a user to start an feed, add a feed, or update the feeds displayed.

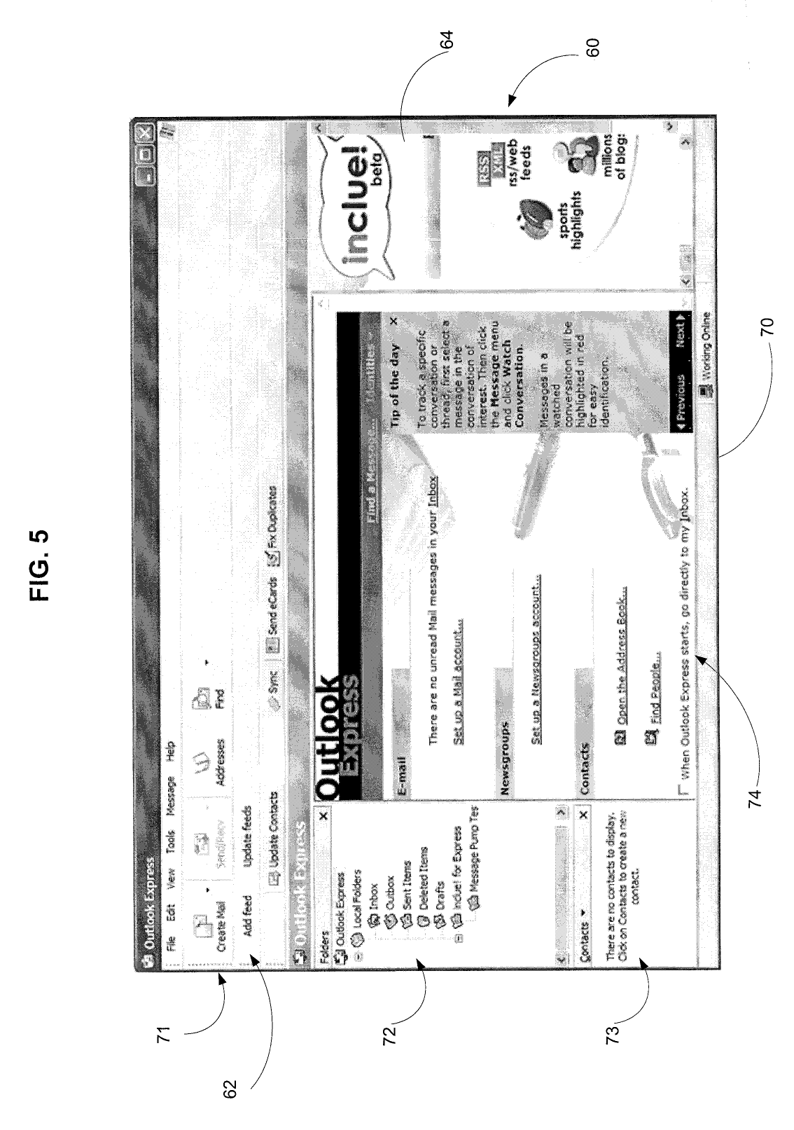

FIG. 5 is an illustrated example embodiment of the present disclosure in connection with an Outlook Express™ screen interface 70. Interface 70 includes button bar 72 for creating mail, checking addresses, and finding emails as shown, and for other common email actions as may be found in the selectable menus. In the embodiment shown in FIG. 5, add/update feed button 62 is positioned below button bar 70. Button 62 can positioned at any location in the email interface. Interface 70 also includes folder section 74, a contacts section 76, and active window 78 which as shown may include links to other functionality. Interface 70 includes panel 60 that contains RSS feed information 64.

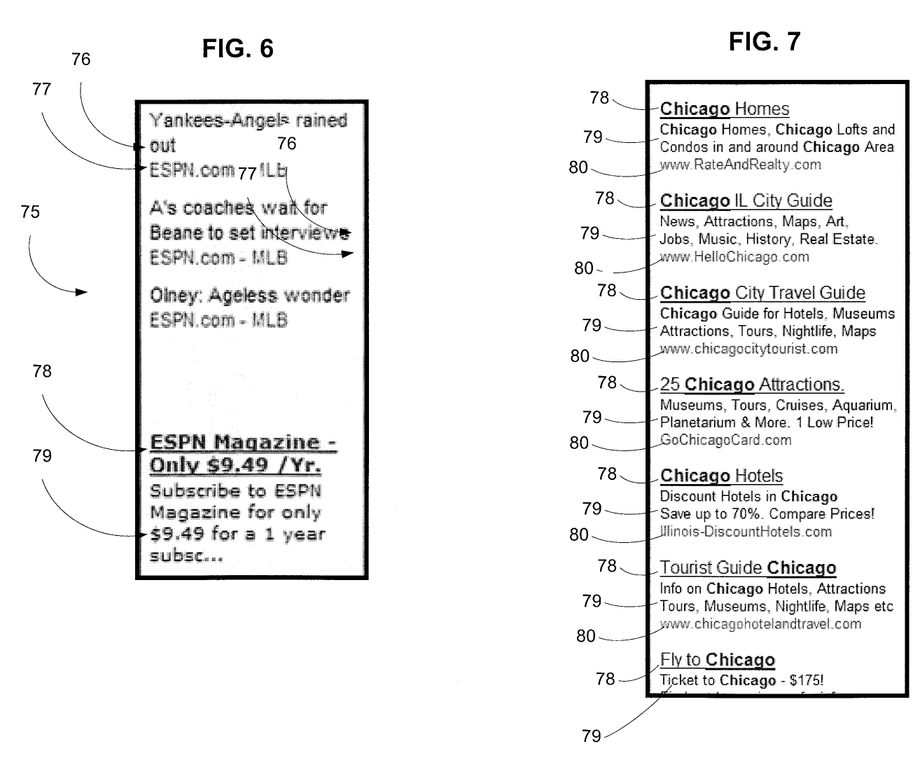

FIG. 6 is one example of information that may be contained in a panel 75. At the top, although position does not matter, panel 75 contains RSS feed information about sports information, although the information can be on any topic. The RSS feed has a headline or text portion 76, and a link portion 77, that in the example shown would forward a user to the ESPN.COM website. Beneath the RSS feed information is an advertisement for ESPN™ magazine, shown with a headline/link portion 78 and text description portion 79. The content of the advertisement is related to the information shown in the RSS feeds. As discussed above, this contextual matching can be performed with a variety of methods, including picking up keywords such as “ESPN” or recognizing a sports theme. The advertising within the RSS feed is thus contextually relevant to the reader. Since the user can select, modify, and/or delete which feeds the user is receiving, the user is thus generally assured to receive advertising related to the user's interests. The user, the advertiser, and the facilitator of the software all benefit. FIG. 7 is an illustrated example of another embodiment of a panel 75. FIG. 7 shows a plurality of advertising links 78, each with a link description 79, and a web site address 80.

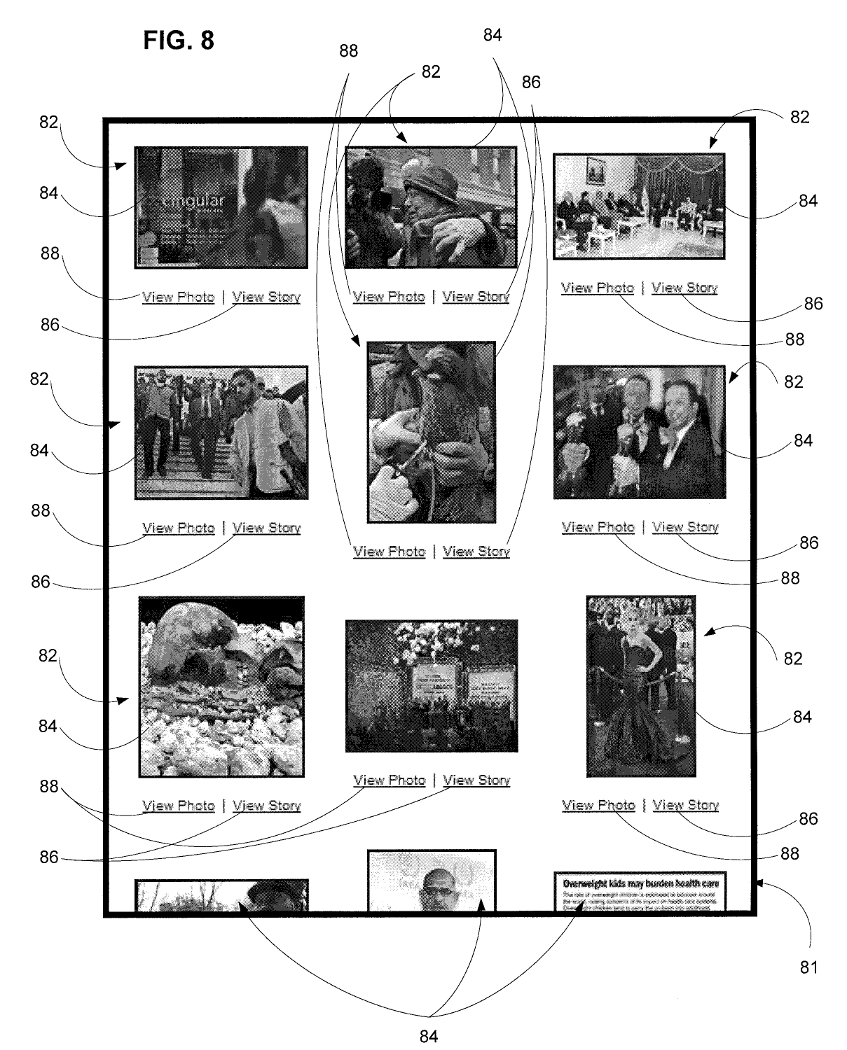

FIG. 8 is an illustrated example of another embodiment of panel 75. A panel 81 includes a plurality of image based feeds 82, each having an image 84, a view photo link 86, and a view story link 86. The image 84 can be a thumbnail, full sized image, or image of any quality or size, and can be static or dynamically updating on a selected or regular interval. The view photo link 88 can lead to another view of the image, such as a full sized or full screen view. View story link 86 can display an entire story, either still within the panel 81, in another panel, or in an external viewer. A particular thumbnail can also be resized by the user or based on settings.

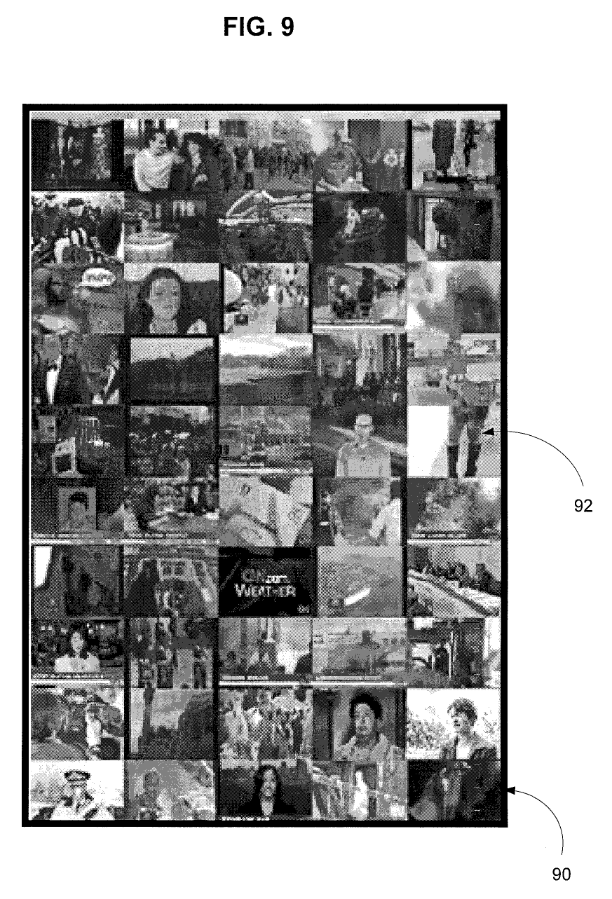

FIG. 9 is an illustrated example of a video thumbnail embodiment 90 of panel 75. Panel 90 includes a number of individual video thumbnails, which may support audio or rollover on selection. The video thumbnails may be displayed in a grid and may be cached locally on the user's computer to increase performance. An individual video thumbnail may also be resizable and may support hyperlinks, external urls, local files, or other file locations. A user can select a particular thumbnail much like selecting a channel on remote control to give the look and feel of channel surfing. A user or the interface may limit the number of individual video thumbnails that appear in order to save bandwidth or screen real estate. The video thumbnails may load in the background, upon being selected, or may cache as appropriate.

The method described above may be performed over any type of communications network which allows for multiple parties to share information including by way of example but not limitation a proprietary communications network, the Internet, or other network which may include one or more of telephones, peer to peer networks, fiber-optics, wireless components, WLAN, cable, satellite, WiFi, cable, WiMax, cellular devices, personal video recorders, set-top boxes, gaming devices, cable boxes, and other forms of distributed communication and information dissemination systems.

The present disclosure also presents a method of preventing click-fraud. Click fraud occurs when a party wishes to take advantage of an entity's existing click-through revenue system by causing the entity to pay for illegitimate click-throughs. The party may wish to receive this revenue directly or to simply force the entity to pay out to others to inflict an economic injury on the entity. Both kinds of fraud typically entail running scripts that create a browser or simulate a browser session, submit a query to a web site that displays a targeted advertisement, and then to “automatically” hit click the advertisement. All of this is done with software. The anecdotal evidence is that this happens 5-20% of the time in the industry and has been going on for a long time. Most firms put up with it as a cost of doing business and provided the return on investment on clicks is sufficient, will continue their ad-click campaigns.

Link exchange providers have strict policies on shutting down accounts of publishers caught doing this. They are usually easy to catch as all of the clicks will come from one IP address. For example, it is unlikely that Joe Smith really searched for and clicked on “snake oil” 5,000 times in one hour. More sophisticated operators try to fake IP addresses. Even this leaves a suspicious trail of spiked traffic. The link exchanges quite often will reimburse parties where it thinks click-fraud has occurred.

The present disclosure substantially solves the problem of click fraud because the advertisements are displayed directly inside the email program, which is difficult to simulate to cause the automatic clicking described above. The disclosed add-on may be used in connection with an IP tracker to verify that the click requests are not all coming from the same, or a predictable, grouping of IP addresses. Generally, moving the click-through advertising to a proprietary system helps to dissuade targeting by click-fraud predators. In an embodiment of the present system, each copy of the add-on program may have a unique identification number, providing for convenient tracking of a click's source. A click's source may also be determined using a combination of the unique identifier and a user's IP address. Such tracking provides for early and convenient detection of click fraud.

The term “module” or “computer module” or “software module” referenced in this disclosure is meant to be broadly interpreted and cover various types of software code including but not limited to routines, functions, objects, libraries, classes, members, packages, procedures, methods, or lines of code together performing similar functionality to these types of coding. The components of the present disclosure are described herein in terms of functional block components, flow charts and various processing steps. As such, it should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices. Similarly, the software elements of the present disclosure may be implemented with any programming or scripting language such as C, C#, SQL, C++, Java, COBOL, assembler, PERL, or the like, with the various algorithms being implemented with any combination of data structures, objects, processes, routines or other programming elements. Further, it should be noted that the present disclosure may employ any number of conventional techniques for data transmission, signaling, data processing, network control, and the like as well as those yet to be conceived. The module may be stored on any known computer readable medium or delivered over any known data transmission signal and the like known or yet to be conceived as well.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the invention are desired to be protected. The applicant has provided description and figures which are intended as an illustration of certain embodiments of the disclosure, and are not intended to be construed as containing or implying limitation of the disclosure to those embodiments. There are a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods that incorporate one or more of the features of the disclosure and fall within the spirit and scope of the present disclosure as set forth in the claims.

What is claimed is:

1. A method for displaying a feed in combination with an email program, the method comprising the steps of:
providing an email program interface, the email program interface being configured to display at least one email; and
displaying at least one feed in at least a portion of the email program interface.

2. The method of claim 1, wherein the feed is at least one of a news feed and a syndicated format feed.

3. The method of claim 2, wherein the syndicated format feed is an RSS feed.

4. The method of claim 3, further comprising allowing a user to do one or more of selecting a feed, modifying a selection of a feed, and deleting a feed.

5. The method of claim 3, further comprising displaying the at least one feed in a panel positioned in proximity to the display of the at least one email.

6. The method of claim 5, wherein the panel resides inside of same application window as the email program interface.

7. The method of claim 5, further comprising displaying at least one advertisement in the panel.

8. The method of claim 7, further comprising displaying the at least one advertisement in the form of a hyperlink.

9. The method of claim 8, furthering comprising displaying the at least one advertisement in combination with a text description.

10. The method of claim 6, further comprising displaying the feed as an image.

11. The method of claim 10, further comprising displaying the image as a thumbnail image.

12. The method of claim 10, further comprising displaying the image as a dynamically changing image.

13. The method of claim 10, further comprising providing a view story link and a view image link along with image.

14. The method of claim 6, further comprising displaying the feed as a video clip.

15. The method of claim 14, further comprising displaying a grid of video clips.

16. The method of claim 15, further comprising caching video clip data prior to displaying the video clip.

17. The method of claim 7, further comprising keying the advertising to the at least one feed to display an advertisement related to the field.

18. The method of claim 17, further comprising performing the keying by one or more of (i) matching keywords, (ii) matching context, (iii) matching phrases, and (iv) matching with metatags.

19. The method of claim 18, further comprising using fuzzy logic to match.

20. The method of claim 17, wherein the displayed advertisement is a sponsored link.

21. The method of claim 17, further comprising the advertisement causing an advertiser's landing page to be displayed and a compensation event to be recorded.

22. The method of claim 21, further comprising recording the compensation event to an ad network.

23. The method of claim 22, further comprising the advertiser compensating the ad network based on one or more compensation events.

24. The method of claim 23, wherein the compensation is based on one or more of pay per click, pay per impression, pay per call, and pay per resulting sale.

25. The method of claim 24, further comprising the ad network sharing at least a portion of the compensation with an internal affiliate tracking system.

26. The method of claim 25, further comprising distributing the at least portion of the compensation from the affiliate tracking system to one or more publishers of feeds.

27. The method of claim 1, wherein the email program interface is web-based.

28. The method of claim 1, wherein the email program interface is client-based.

29. The method of claim 28, wherein the email program is Microsoft Outlook.

30. A system for distributing a feed inside of a delivered email, the system comprising:
an email system;
an add-on module installed in connection with the email system, the add-on module adapted to display the feed inside at least one email delivered by the email system; and
a publisher selectively in communication with the email system, the feed publisher providing the feed to the add-on module.

31. A computer program product for distributing a feed inside of a delivered email for use with a computer system operatively coupled to a computer network comprising a computer usable medium having code embodied thereon, the code comprising:
a software module adapted to overlay a feed on a delivered email; and
a software module adapted to allow a user to subscribe to one or more feeds.
